(19) United States
(12) Patent Application Publication
(10) Pub. No.: US 2005/0102168 A1
(43) Pub. Date: May 12, 2005

(54) Collateral coverage for insurers and advisors

(76) Inventors: Bruce Bradford Thomas, Trumbull, CT (US); Lester Ware Preston III, Darien, CT (US)

Correspondence Address: Bruce Bradford Thomas, 145 Lake Avenue, Trumbull, CT, 06611, US

(21) Appl. No.: 10/705,439

(22) Filed: Nov. 10, 2003

(51) Int. Cl. G06F 17/60

(52) U.S. Cl. 705/4

(57) ABSTRACT

A method for underwriting and adjusting loss experience based on the premiums paid for and the losses recovered from insurance and reinsurance policies.

This invention relates to providing coverage for loss expenses that are difficult or impossible to insure.

### BACKGROUND OF THE INVENTION

Insurance is a means by which the risk of loss is contractually shifted from the insured to the insurer. Under this contractual arrangement, the insured pays a premium to the insurer for agreeing to bear some potential loss that the insured faces.

Underwriting

Not all potential losses are insurable and an insurer must expend significant efforts to ensure that applicants have met its standards. This process is known as underwriting. Although such standards encompass many elements, there are two elements that are of particular importance. The causes of loss that are covered by an insurance policy must be defined and the policy must carry a premium that is reasonable in relation to the potential for loss.

Because the terms of insurance are relatively complicated and the coverage definition is critically important to both the insurer and insured, extensive consideration is warranted. Since insurers have much greater expertise in this area, most insurance buyers use insurance agents and brokers to help them make good purchasing decisions.

Loss Adjustment

Substantiating insurable losses can be very expensive for both insureds and insurers. Insurers categorize their costs associated with determining whether losses occurred and to what extent they are covered under the insurance policies that they write as loss adjustment expenses.

In instances where coverage exists, claimants must spend considerable effort identifying and substantiating their losses. For large claims, it is not unusual for individuals and companies to hire their own adjusters and accountants to ensure that they get the most out of their insurance.

Loss Definition and Valuation

Insurance works best in instances where the definition of loss is obvious and the amount of loss is clear. If a loss is not easy to define or prove, it should not be insured because it will result in unduly complex coverage terms, disagreements over coverage interpretation, and difficulties in proving and quantifying losses. Because insurance is based on the principle of indemnity, it is impossible to obtain a reimbursement for a loss without substantiating the amount of the loss. For most losses this is problematic, and for many losses this is impossible.

To be eligible to receive insurance payments, insurance buyers must be able to prove that they had losses and that those losses fit within the coverage definition of their insurance. Losses can be categorized in many different ways such as life, health, property, casualty, etc. More generally, losses can be categorized as being direct or collateral.

A direct loss is a loss where the insured peril is the proximate cause of the loss. For example, the direct loss of a factory due to a fire would be the cost of rebuilding the factory. The indirect losses would be all of the costs associated with the inconvenience of not having a workable factory. Direct losses, such as the physical cost of the buildings in this example, are typically much easier to estimate than indirect losses such as lost income or extra expenses that may result from such an event. Management and employees must spend time trying to recover from this event, and there is always a significant amount of opportunity cost that can never be adequately assessed.

Consider for example the loss of an automobile. Since it is a physical thing, it should be obvious that there was a loss and the extent of that loss. Nevertheless, the indirect costs (for example lost time and other expenses) associated with fixing or replacing the car and the opportunity costs of not having a working car are not typically covered by insurance. Similarly, insurance may cover the direct cost of paying for and defending against a liability claim, but it typically would not cover the costs necessary to restore an entity's reputation via an advertising program or to institute new practices and procedures.

Indirect losses vary in size depending on the specifics of the loss, but they occur with every type of insurable loss. Although insurance can cover certain limited types of indirect costs such as the loss of income and “extra” or “expediting” expenses that are necessary to return a business to normal after a loss, companies and individuals are not typically insured against indirect losses because these losses are too difficult to define in advance or prove after the fact to make an insurance transaction economically viable.

Furthermore, policyholders often have considerable discretion over indirect losses, making them impossible to quantify and subject to significant moral hazard. Since indirect losses are becoming an ever larger part of most companies' loss experience, it is no wonder that companies are increasingly frustrated with insurance.

One consequence of having a large loss is that an entity's future insurance premiums may increase. Since this additional cost is not subject to the discretion of the insured, it is relatively easy to finance. To the extent that an insured is interested in purchasing this kind of coverage, an insurance company could just charge some extra amount of premium to smooth the eventual cost of the premium increase. This financing mechanism is similar to a heating oil company that charges its customers more than it would otherwise charge in the summer, when oil prices are lower, and less than it would otherwise charge in the winter. This smoothes the price variation of oil so its customers can more accurately budget for their heating cost.

For clarity, we are defining “collateral losses” to be a subset of indirect losses that have not been covered by insurance because they are subject to the discretion of the insured. Collateral losses arise from insured events but are too difficult to define, prove, or measure to be covered by an insurance policy in the traditional way. Collateral losses include but are not limited to such things as: lost income, lost productivity, credit losses, additional borrowing costs, reputation maintenance expenses, claim expenses, accounting expenses, legal costs, consulting, and other types of discretionary expenses.

Moral Hazard

Because insurance limits are often over a hundred times more than insurance premiums, the insured's personal habits, morals, and attitude toward losses are very important. Insurers attempt to reduce moral hazard by instituting deductibles, coinsurance clauses, and reduce insurable limits. This may dissuade applicants who are more predisposed to losses from selecting a given insurer, and it helps change attitudes toward potential losses by forcing insureds to retain a larger share of those losses. Unfortunately, each of these measures also means that the insured is never fully compensated for a loss. While insurers may have reduced moral hazard, they have done so at the cost of making insurance less valuable to the insured.

Agreed Value

Even when it is relatively easy to substantiate that a direct loss has occurred, it is not always easy to determine the value of that loss. In relatively simple cases, the insured must show receipts, appraisal documents, or other evidence that would substantiate value. Often appraisers must be called in to provide their opinions about value.

In many cases, the value of something may be open to interpretation. One technique that insurers have employed in circumstances where losses are relatively easy to substantiate but difficult to value, is to objectify the loss value at the time a policy is written.

Life policies operate on the principal of agreed value. Rather than attempt to dispute how much a life is worth after it is over, insurers and insureds agree to a certain value up-front and base premiums on that value. This principle is also employed for certain very special risks such as the value that was placed on Betty Grable's legs or the successful launch of an Ariane rocket.

Inventory or cargo insurance is another example of where this principle has been applied to direct losses. With inventory it is generally accepted that different types of companies have incurred costs that are greater than the purchase price of the goods they own. From an economic perspective, the value is not the invoice cost but the replacement cost of the inventory at a particular stage in the production, transportation, and retailing process.

Rather than dispute this point, insurers and insureds often agree to a stated percentage above the purchase price of the goods. Under this arrangement, the insurer and the insured increase the limit of the insurance to some commercially reasonable amount, and the price of this coverage is increased to take account of the higher loss valuation.

Thus, if the insured chooses to buy this extra coverage in an amount of 10% and has a loss, the insured will be paid the invoice amount for the goods that were lost plus an additional 10%. In this example, it is easy enough to define the potential losses in advance and to prove those losses after the fact, but the use of the agreed value principle helps eliminate the expense of having to measure the loss.

Transaction Costs

Selecting coverage, defining losses, and meeting other insurance requirements can be very burdensome for both insurers and their customers. In the year 2001, US property and casualty insurers spent more than $133 billion dollars in brokerage commissions, underwriting, and loss adjustment expenses. This amount represents approximately 39% of the premium dollars that they earned in that year.

Moreover, this amount does not reflect the significant costs that insurance buyers expended in getting coverage, substantiating their losses, and proving that those losses were covered under their insurance policies. The amount of time and expense that is involved in buying insurance and collecting on it can be very discouraging to insurance buyers, and it places new burdens on them when they are least able to deal with them.

Furthermore, it is not unusual for there to be disputes about what was covered, after a loss has occurred, and many claimants initiate litigation proceedings against their insurers to force them to pay. The inability to define in advance all the losses that will be covered by the policy makes it difficult for the insurance buyer to assess the value of the insurance policy and makes it equally hard on insurers to determine a fair premium.

The high cost of underwriting and loss adjusting are also huge deterrents to companies that would like to finance insurable risk. In effect, the large transaction costs associated with insurance represent a huge barrier to entry that discourages third parties from offering coverage and increases the cost of capital that is necessary to finance risk.

Reinsurance

Reinsurance is essentially insurance for insurance companies, and it is reasonable to think of reinsurance as a special form of insurance. In practice, reinsurance faces all of the same issues that insurance does, and a significant amount of time and resource is spent underwriting, defining covered losses, and in the loss adjustment process. Also, it is often difficult to make a clear distinction between insurers and reinsurers since most of the largest insurance and reinsurance companies have business units that write both insurance and reinsurance.

Reinsurance enables insurers to buy protection against certain potential losses by paying premiums to another insurer called a reinsurer. Using this mechanism, an insurer can reduce its risk of loss by ceding risk on an individual basis (facultative reinsurance) or on a large number of risks (automatic reinsurance).

Reinsurance can be classified as either proportional or non-proportional in relation to the underlying insurance policies. Under proportional reinsurance, a reinsurer agrees to assume some proportionate share of the premiums and losses of the underlying insurance policies.

Quota share reinsurance is a type of reinsurance that is both automatic and proportional. Under this arrangement, a reinsurer agrees to accept a given percentage of every risk within a certain defined category that an insurer writes in return for the same percentage of premium. Thus, in the case of 30% quota share, a reinsurer must pay 30% of any loss that is sustained on exposures within a given risk class in return for receiving 30% of the premiums for that same class of risk.

By employing a coverage mechanism that is proportional and automatic, insurers and reinsurers can reduce the underwriting and loss adjustment expenses that would otherwise be a part of their reinsurance agreements. However, this technique is only used to share risks between insurers and reinsurers. The original insured is not involved in reinsurance transactions and gains no additional coverage as a result of it. Moreover, the insurer is obligated to pay the insured regardless of whether the reinsurer pays the insurer.

Retrocession

Retrocession is the term that describes the reinsurance of a reinsurer. Retrocession is used by reinsurance companies to reduce their exposures to certain types of risk.

Derivatives

Derivatives are financial contracts whose pay-offs are based on the performance of an underlying asset, index, or reference rate. They include options, futures, forwards, and swaps. Derivatives may be used to speculate, by permitting investors to assume additional risk, or to hedge risk, by allowing entities to transfer risk to other market participants.

As a risk management tool, derivatives are commonly used to reduce market-based risks such as interest rates, currency rates, or price levels of commodities and financial assets. Because these types of risk are exogenous to any particular entity, they have certain qualities such as transparency and non-manipulability that permit them to be traded in a standardized and highly efficient way.

Generally speaking, companies can use financial contracts to hedge against changes in market rates and prices but not against their own idiosyncratic risk. Companies must manage these risks by themselves or, to the extent they can, buy insurance.

Securitization

Attempts have been made to standardize certain types of insurable risks, embed those risks in financial instruments, and trade them. During the 1990's, a number of efforts were made to develop catastrophe indices and related financial contracts that could be used to transfer the more exogenous parts of the insurance industry's loss experience. The most notable of these efforts were undertaken by the Insurance Services Office, Property Claims Services, and IndexCo. Each of these companies produced and published catastrophe indices that were the basis for derivative contracts that were traded on either the Chicago Board of Trade or the Bermuda Commodities Exchange.

Such large-scale efforts to standardize insurable risk have largely been abandoned. However, a number of insurers and reinsurers have had some limited successes in creating bond instruments and other types of securities that have enabled them to transfer a portion of their insurable risks to others. These transactions typically involve transferring catastrophic risks such as earthquake and hurricane losses that are considered to be substantially outside of any particular insurer's and reinsurer's ability to control or influence.

These transactions share some similarities to reinsurance, and it is not uncommon for reinsurers to be some of the largest investors in these deals. However, these types of transactions have never been based on a single insurance or reinsurance policy. In addition, there is no standard relationship between the price that is charged and the coverage that is provided by a securitization in relation to the underlying insurance or reinsurance policies.

Instead, the price of a securitization is a function of how well a given transaction is received by the market at the time a deal is executed as well as the coverage that is provided. Although coverage may be described in a variety of ways, it often begins at some relatively high loss threshold and typically includes multiple provisions that must be satisfied before any payments are due. Furthermore, securitizations are often “funded” to eliminate credit risk. This necessitates the inclusion of a large interest rate component that is typically absent in most insurance or reinsurance transactions which are often highly levered.

Problems that Insurers and Reinsurers Face

Insurance and reinsurance companies face many of the same choices and problems that individual insureds confront. They can either do without some form of risk protection from other parties or purchase some form of coverage to help mitigate their potential losses. Like primary insurance, the risk financing mechanisms available to insurers and reinsurers involve very high transaction costs, typically in the range of 30% to 40% of every dollar of reinsurance premium, and the collateral costs of the losses they sustain are not typically covered.

The most obvious and significant of the collateral costs that an insurer or reinsurer might confront is the cost of collecting the funds that they are due under a reinsurance treaty or other risk financing mechanism. This involves substantial work on the part of the insurer or reinsurer and often necessitates a legal battle before a dispute can be resolved. Also, resolution often involves accepting some amount that is considerably less than what the insurer or reinsurer believes it is owed under the contract. Thus, a large part of the collateral costs that insurers or reinsurers bear when buying coverage is related to their counterparties credit worthiness and willingness to pay.

Because these costs are difficult to define in advance or prove after the fact, and because they are incurred at the discretion of an insurer or reinsurer, they do not meet the classical definition of insurable losses. Although it is impossible to obtain overall market statistics that describe the total collateral costs of insurers and reinsurers, it is reasonable to believe that this amount is in the billions of dollars annually.

Problems that Reinsurance Advisors Face

Reinsurance brokers and other third-party advisors that are connected to the reinsurance industry are subject to boom and bust periods as the fortunes of the reinsurance industry change and as business volumes rise and fall with particular market conditions. These changes can cause significant volatility in earnings as advisors and other third parties find that they either have too much or too little capacity. The property catastrophe business is a good example.

Most of the time, there are no catastrophes so the reinsurance intermediary is content to have a relatively small staff of claim experts and processors. When there is a catastrophe, they are deluged with work, and their expenses increase dramatically as they struggle to honor their commitments to process and prosecute their clients' catastrophe claims.

Because these extra costs are difficult to define and prove and are to a large degree incurred at the discretion of the intermediary, they do not meet the classical definition of losses that are insurable. Thus, reinsurance advisors are stuck with a substantial business risk that is collateral to the reinsurance transactions that they help place.

New Approach Needed

Given high transaction costs and the necessity of defining and proving losses, it becomes clear that insurance and reinsurance are risk financing solutions with significant limitations. Insurance and reinsurance proceeds are supposed to restore the policyholder to the same exact position that existed before the loss occurred. In practice, this is impossible. Collateral losses, deductibles, coinsurance, and coverage limits mean that the insured will never be fully recompensed for its losses.

Clearly another approach is needed. Such an approach would permit more of the uncertainty associated with insurable losses to be objectified and would reduce the transactional burdens that are placed on the parties to an insurance or reinsurance contract.

### BACKGROUND OF INVENTION—OBJECTS AND ADVANTAGES

The object of the invention is a method for applying the concept of Secondary Loss Expense Coverage to the loss expenses of insurers, reinsurers, and third parties that may be involved in the reinsurance business, such as reinsurance brokers. These expenses are currently either expensive or impossible to insure and include collateral losses such as claim, credit, administrative, management, accounting, legal, reputation maintenance, loss of income due to productivity impairment and other types of expenses.

Secondary Loss Expense Coverage was originally conceived as a means of helping companies other than insurers and reinsurers obtain a new and more cost-effective way to finance the aforementioned types of expenses based on a set of relationships to an insurance policy. However, subsequent investigations have demonstrated that this concept also holds great promise as a means of helping insurers, reinsurers, and other parties that may be involved in the reinsurance business obtain collateral coverage at attractive prices.

Collateral Coverage eliminates most of the transaction costs that an insurer or reinsurer would typically incur in purchasing insurance because it does not require lengthy or expensive underwriting and loss adjustment processes the way insurance does. As a result, it also eliminates more than 75% of the transaction costs that insurers and reinsurers typically have in providing insurance or reinsurance coverage. These costs include sales, underwriting, and loss adjustment expenses and typically amount to between thirty and forty percent of property/casualty premium dollars in the United States. Reducing these costs increases profits for coverage sellers and enables them to reduce premiums for coverage buyers.

Collateral Coverage is extremely versatile from a contractual perspective and may be structured as an insurance policy or as some other type of contract. This is important because it enables companies and individuals that are not licensed as insurers or reinsurers to provide this coverage.

By substantially eliminating the underwriting and loss adjustment processes that are necessary to provide insurance or reinsurance-type coverage and by reducing the licensing limitations of insurance regulation, Collateral Coverage reduces barriers to entry and enables companies other than insurers and reinsurers to finance the risk of collateral losses. This gives coverage buyers access to new sources of risk capital and is particularly valuable in “hard” insurance markets when prices are high and coverage is difficult to obtain.

There are an infinite variety of ways to define the mathematical relationship between the price and coverage of Collateral Coverage in relationship to the premium paid for and the losses recovered under a separate insurance or reinsurance policy. This is useful because it enables coverage buyers and sellers to create risk transfer products that are tailored to their own specific needs.

Collateral Coverage also permits access to cheaper sources of capital than any other existing financial alternative. This is because individual insurers and reinsurers exhibit much greater loss volatility than do the insurance or reinsurance industries as a whole. By offering Collateral Coverage to insurers and reinsurers, a coverage provider can mimic the loss experience of these industries and reduce its loss volatility. This will diminish the amount of capital that is needed to finance this risk while making the coverage providers significantly more attractive to investors since higher returns and lower profit volatility is exactly what investors want. These benefits can then be shared with coverage buyers in the form of lower premiums.

Furthermore, Collateral Coverage permits third parties that are involved in the reinsurance business to gain coverage based on reinsurance that someone else has. This would be useful to reinsurance brokers since it provides them with a way of reducing the volatility associated with their expenses. Although this risk is not currently insurable, it is collateral to the reinsurance transactions on which they work and it can be managed by using Collateral Coverage.

Further objects and advantages are to provide a cheap, efficient, and convenient means of providing insurers, reinsurers, and reinsurance third parties with an effective means of covering their loss expenses. Other objects and advantages will become apparent from a consideration of the ensuing description and drawings.

### SUMMARY

This method permits the selection of loss expense coverage, underwriting, and loss determination processes of insurance and reinsurance to be performed by reference to an insurance or reinsurance policy or group of such policies.

### DRAWINGS—FIGURES

FIG. 1 shows a Collateral Coverage Contract that bears a functional relationship between its premiums and the premiums paid for the underlying insurance policy or policies as well as a functional relationship between the losses that are recovered under the two contracts.

FIG. 2 shows a Collateral Coverage Contract that uses functional relationships to an underlying reinsurance policy or group of such policies to determine the coverage it will provide and the amount of premium that will be charged for this contract.

FIG. 3 is a chart and a table that demonstrates the relationship between a 30% Proportional Collateral Coverage Contract and a reinsurance policy and shows the costs and benefits of this coverage.

FIG. 4 is a flowchart that demonstrates how simple and cost effective it is to perform underwriting and loss adjustment functions when the premiums and losses of the Collateral Coverage Contract bear functional relationships to the premiums of an insurance or reinsurance policy, or group of policies and the losses recovered under those policies. FIG. 2 shows the relationship between a Collateral Coverage Contract and an underlying reinsurance policy or policies and outlines the various parties to these contracts.

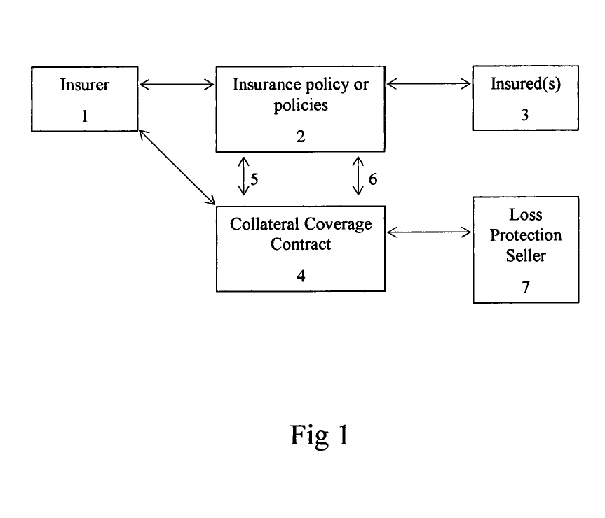

### DETAILED DESCRIPTION—FIGS 1-4—PREFERRED EMBODIMENT

Product Overview

FIG. 1 shows how a Collateral Coverage Contract's premiums and the losses may be related to the premiums paid for and the losses recovered under an insurance policy or group of policies. It also shows the various parties to these contracts. An insurer 1 writes insurance policies 2 for an insured or group of insureds 3. The insurer uses a Collateral Coverage Contract 4 to purchase collateral loss expense coverage based on the performance of the insurance contract or group of contracts it has written 2.

The Collateral Coverage Contract has two pre-specified functional relationships to the insurance policy: the contract's losses 5 are a function of the losses that are recovered under the insurance policy; and the contract's premiums 6 are a function of the insurance policy's premiums. Although this relationship may be expressed in many different ways, it must give the insurer value and allow a loss protection seller 7 to make money. The loss protection seller 7 may be another insurer, a reinsurer, or some other entity that is interested in providing Collateral Coverage.

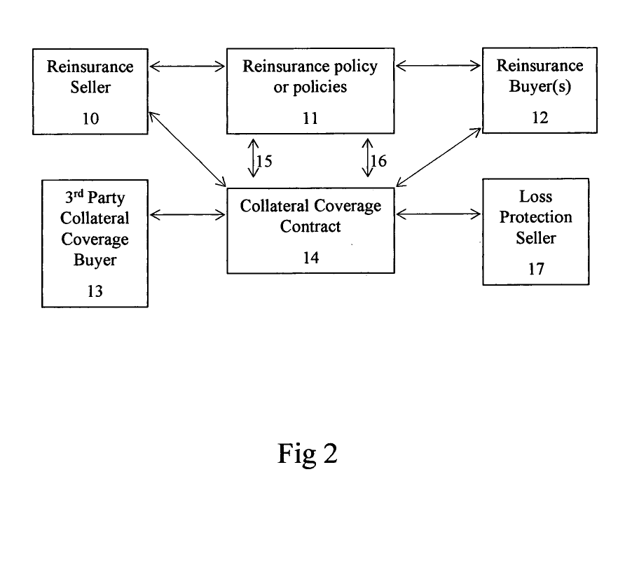

FIG. 2 shows how a Collateral Coverage Contract may be used in conjunction with a reinsurance policy or group of reinsurance policies. A reinsurer 10 writes reinsurance policies 11 for reinsurance buyers 12 such as insurers and reinsurers. The loss protection seller 17 may be another insurer, a reinsurer, or some other entity that is interested in providing Collateral Coverage.

The Collateral Coverage Contract 14 has two pre-specified functional relationships to the reinsurance policy: the contract's losses 15 are a function of the losses that are recovered under the insurance policy; and the contract's premiums 16 are a function of the insurance policy's premiums. Although this relationship may be expressed in many different ways, it must give the buyer value and allow a loss protection seller 17 to make money.

There are three potential types of Collateral Coverage buyers. Third parties 13, such as reinsurance brokers that have a collateral interest in the performance of the reinsurance contract, may desire to buy a Collateral Coverage Contract 14. The reinsurance seller 10 and the reinsurance buyer 12 may also desire to purchase a Collateral Coverage Contract 14.

Some basic pricing and coverage rules describe how these criteria can be met. The value of Collateral Coverage is always established provided that the price of this coverage is the same as or less than the separate insurance or reinsurance coverage on a dollar of premium for dollar of insured limit. In essence, an insured has indicated that this coverage has value at this price by its willingness to pay this premium for the underlying insurance or reinsurance.

Thus, if the underlying coverage is $10 million and cost $1 million, Collateral Coverage can be sold at a ratio of $10 of limit to $1 of premium and provide value to a protection buyer. In certain circumstances, Collateral Coverage may be of much greater value than this relationship suggest. In which case, a higher Collateral Coverage premium could be charged and still provide value to the buyer. For example, in “hard market” conditions or in cases where loss costs are particularly difficult to determine, Collateral Coverage may be significantly more valuable to coverage buyer than the ratio of insured limit to premium on the underlying insurance policy.

Because it reduces underwriting and loss adjustment expenses by more than 75%, Collateral Coverage can be sold at a substantial discount to an underlying insurance or reinsurance policy and still provide value to both coverage buyers and coverage sellers. Assuming that underwriting and loss expenses are approximately 40% of premiums, as they typically are for most US property/casualty insurance, a Collateral Coverage seller could reduce its premium rate by 30% in relation to the underlying insurance and still earn the same rate of return that the insurance company would earn on the underlying insurance policy.

In the reinsurance market where transaction expenses are approximately 35% of premiums, a Collateral Coverage seller could reduce its premium rate by 26% in relation to the underlying reinsurance and still earn the same rate of return that the reinsurer on the underlying reinsurance policy would earn.

Because Collateral Coverage substantially eliminates traditional insurance and reinsurance transaction costs, it reduces important barriers to entry in the insurance and reinsurance markets and allows new entities to offer coverage.

Cost/Benefit Analysis

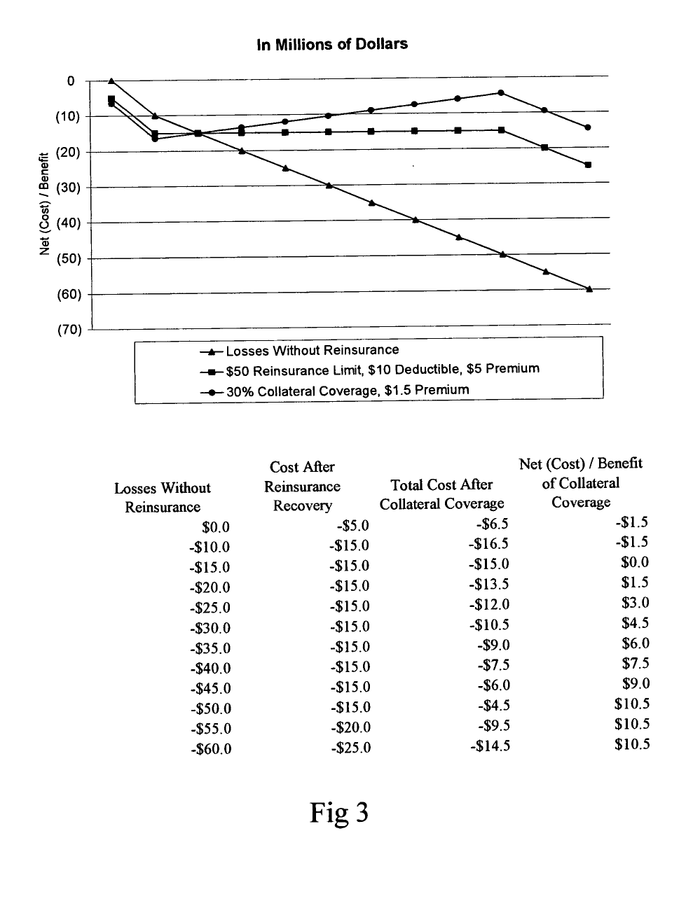

FIG. 3 illustrates the cost and benefits of Collateral Coverage in relation to a reinsurance policy. In this example, an insurer is concerned about catastrophic losses that it may have. It is considering the purchase of a reinsurance policy to cover pre-specified losses that might occur in the range from $30 million to $100 million. The insurer recognizes that there are likely to be collateral losses that are uninsurable over this range of loss experience and would like to obtain coverage for them if possible. The insurer has three choices.
a. Buy no reinsurance and suffer losses as they occur.
b. Purchase a reinsurance policy for a premium of $5 million that contains a deductible of $10 million and a coverage limit of $50 million.
c. Buy the reinsurance policy and supplement it by purchasing Collateral Coverage equal to 30% of the reinsurance policy on a proportional basis. This would cost 30% of the reinsurance policy's premiums, or an additional $1.5 million, and would pay 30% of any losses that are recovered under the reinsurance policy.

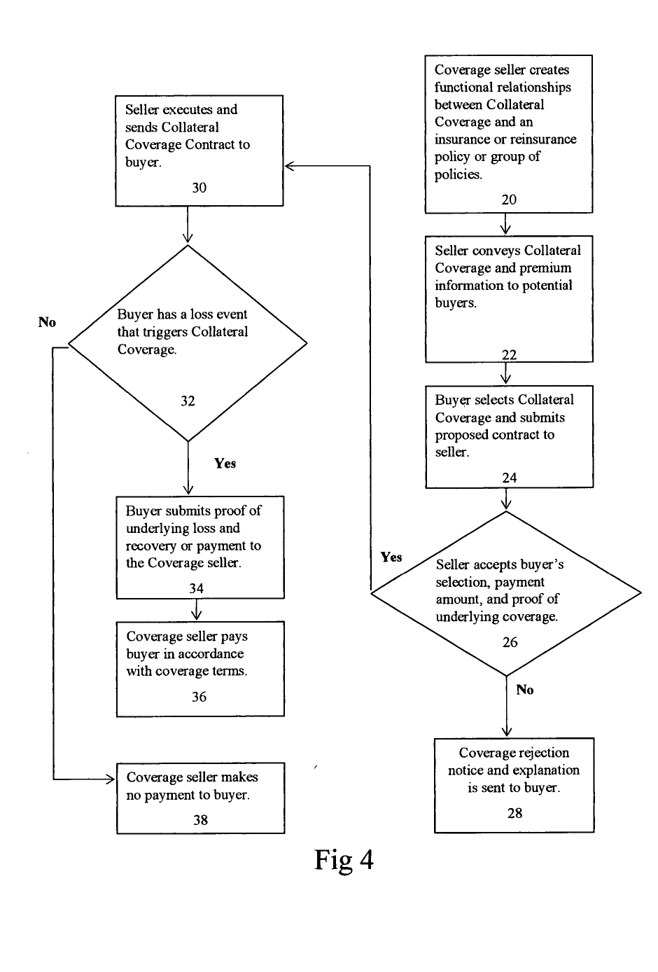

The graph in FIG. 4 shows the net cost or benefit of each of these options over the relevant range of loss experience. The total cost or benefit equals the loss amount minus premiums and deductibles, plus any insurance and any Collateral Coverage recoveries.

The $5 million cost of insurance premiums and the $10 million deductible prevent the reinsurance option from offering any real benefit until after there has been at least $15 million of covered losses. This breakeven point for reinsurance would be higher to the extent that there are collateral losses that are not insurable such as legal cost or credit losses that are necessary to obtain the reinsurance recovery.

The 30% proportional Collateral Coverage would provide significant benefits to the insurer for covered losses that are greater than $16.5 million, which is the cost of the reinsurance and Collateral Coverage premiums plus the reinsurance deductible. As the loss experience gets worse, Collateral Coverage begins to make up for the premiums and the deductible that the insurer must pay. Alternatively, the Collateral Coverage could be used to cover the additional collateral losses that the insurer is concerned about. These losses cannot be covered in an economically feasible way by traditional reinsurance because they are too difficult to define in advance or to prove after the fact.

Method of Underwriting and Loss Adjusting

The flowchart in FIG. 3 illustrates how an entity that desires to sell Collateral Coverage could use this business method to eliminate most of the work that is currently required to underwrite loss coverage and to adjust claims. First, a coverage seller creates two functional relationships 20. One relationship defines the losses covered by Collateral Coverage in terms of the losses that will be recovered under an insurance or reinsurance policy or group of such policies and the second relationship defines the premium of the Collateral Coverage Contract in terms of the premiums paid for these policies. Next, the coverage seller uses some means of communicating this information about its willingness to offer coverage on these terms to potential buyers 22. This could be communicated via an intermediary, a telephone, radio, mail, the internet, or any other means of communication. For example, the following schedule might be used to communicate that the coverage seller is willing to provide Collateral Coverage on a basis that is proportional to the underlying insurance or reinsurance.

| Coverage | Price |
|---|---|
| 10% of loss recoveries | 10% of premiums |
| 15% of loss recoveries | 15% of premiums |
| 20% of loss recoveries | 20% of premiums |
| 25% of loss recoveries | 25% of premiums |
| 30% of loss recoveries | 30% of premiums |

Next, a buyer selects the most appropriate coverage amount based on her expectation of how much additional loss expense she might have over her reinsurance coverage and submits a proposed contract to the coverage seller for execution 24.

The coverage seller reviews the buyer's coverage submission request along with proof of the underlying insurance or reinsurance coverage and payment 26. If there is something wrong with the submission, it would be rejected with an explanatory note sent back to the buyer 28. For example, the buyer may not have submitted proper proof of the underlying coverage or may not have sent the proper payment amount.

Assuming the coverage submission is accepted, the coverage seller would send an executed contract to the buyer 30. This contract could be issued in the form of an insurance or reinsurance policy or some other type of contract.

If the Collateral Coverage buyer has a loss event 32, the buyer submits proof of the payment that it received from its separate reinsurance contract to the Collateral Coverage seller 34. The Collateral Coverage seller pays the buyer in accordance with the contract terms 36. If the buyer does not receive a payment under its reinsurance policy, the Collateral Coverage seller would make no payment to the buyer 38.

Additional Embodiments

Although the basic methodology for Collateral Coverage remains the same as described above, there are numerous embodiments of this concept. This method can be applied to all types of insurance policies including property, casualty, health, and life insurance. Collateral Coverage can be offered by insurers, banks, or other types of entities. Collateral Coverage can be offered in the form of an insurance policy, act as an endorsement to an existing insurance or reinsurance policy, or take many other contract forms. Collateral Coverage may be offered in amounts that are proportional (i.e. a straight percentage) or nonproportional to the premiums paid for and the losses that are recovered from an underlying insurance or reinsurance policy. Moreover, a Collateral Coverage Contract may be constructed so that its premium bears no functional relationship to the premium of the policy that is used to determine the contract's losses because the Collateral Coverage Contract's premiums are determined by using some other underwriting methodology.

Advantages

From the description above it should be clear that this process satisfies many purposes that can not be accomplished via traditional insurance, reinsurance, or any other financial technique, operation, or type of contract that is currently in use to fund additional loss expenses. By simplifying the insurance and reinsurance process, this method reduces transaction costs by as much as 75%, eliminating the need:
(a) To define coverage in terms of loss events;
(b) To separately underwrite each risk;
(c) For an extensive and cumbersome sales process;
(d) For proof of actual losses; and
(e) For a lengthy or disputatious claims adjustment process by the coverage provider.

This methodology also:
(f) Permits buyers to receive coverage for losses that are currently difficult or impossible to insure;
(g) Allows entities to select the amount of coverage and relationship to underlying loss experience that best suits their needs;
(h) Allows insurers and reinsurers to offer a new form of coverage to customers;
(i) Permits the coverage to be structured as insurance, reinsurance, or as some other type of financial contract;
(j) Gives insurance and reinsurance buyers access to new sources of capital by permitting third parties to offer them coverage;
(k) Reduces the costs of coverage permitting significant premium reductions;
(l) Permits non-insurers to offer loss coverage; and
(m) Introduces more price competition into the insurance and reinsurance markets by reducing the huge infrastructure costs that have previously been necessary to offer coverage.

Although the description above contains certain specifics, these should not be construed as limiting the scope of the invention but as merely providing illustrations of some of the presently preferred embodiments of this invention. Clearly this methodology can be applied in many ways to all types of insurance and reinsurance and can be structured as insurance, as reinsurance, or as other types of financial contacts or separate provisions of other contracts. Thus the scope of the invention should be determined by the appended claims and the legal equivalents, rather than by any particular example described above.

1. A method for defining collateral loss coverage as a mathematical function of the recovery on one or more coverage parts of an insurance policy or group of insurance policies that are written by an insurer:
(a) using a contract that enables an exchange of money between two parties, where said insurer is a coverage buyer,
whereby simple and cost efficient coverage may be provided for losses that are expensive to define or prove.

2. The contract of claim 1(a) that is structured as one or more provisions in any type of non-insurance contract.

3. The contract of claim 1(a) where said contract's loss coverage is proportional to the losses recovered under said coverage parts of an insurance policy or group of insurance policies.

4. The contract of claim 1(a) where said contract's loss coverage is nonproportional to the losses recovered under said coverage parts of an insurance policy or group of insurance policies.

5. A method for defining collateral loss coverage as a mathematical function of the recovery on one or more coverage parts of a reinsurance policy or group of reinsurance policies:
(a) using a contract that enables an exchange of money between two parties, whereby simple and cost efficient coverage may be provided for losses that are expensive to define or prove.

6. The contract of claim 5(a) that is structured as one or more provisions in any type of non-insurance contract.

7. The contract of claim 5(a) where said contract's loss coverage is proportional to the losses recovered under said coverage parts of a reinsurance policy or group of reinsurance policies.

8. The contract of claim 5(a) where said contract's loss coverage is nonproportional to the losses recovered under said coverage parts of a reinsurance policy or group of reinsurance policies.

9. A method for predefining acceptable mathematical functions of collateral loss coverage and collateral loss premiums based on the losses paid by and the premiums paid for one or more coverage parts of a reinsurance policy or group of reinsurance policies:
(a) using a contract that enables an exchange of money between two,
(b) using a means of communicating this information to potential counterparties that may want to enter into said contract,
whereby simple and cost efficient coverage may be provided for losses that are expensive to define or prove without the need for extensive negotiations.

10. The contract of claim 9(a) that is structured as one or more provisions in any type of non-insurance contract.

11. The contract of claim 9(a) where said functional relationships are proportional to the premiums charged for and the losses paid by said coverage parts of a reinsurance policy or group of reinsurance policies.

12. The contract of claim 9(a) where said functional relationships are nonproportional to the premiums charged for and the losses paid by said coverage parts of a reinsurance policy or group of reinsurance policies.
